(19) United States
(12) Patent Application Publication
(10) Pub. No.: US 2026/0163841 A1
(43) Pub. Date: Jun. 11, 2026

(54) ALLEVIATING CONGESTION AT A RECEIVER FOR IN-CAST TRAFFIC

(71) Applicant: Advanced Micro Devices, Inc., Santa Clara, CA (US)

(72) Inventors: Ravi NITTALA, Santa Clara, CA (US); Harinadh NAGULAPALLI, Santa Clara, CA (US)

(21) Appl. No.: 18/976,109

(22) Filed: Dec. 10, 2024

(51) Int. Cl. H04L 47/30; H04L 47/12; H04L 67/1097

(52) U.S. Cl. CPC H04L 47/30; H04L 47/12; H04L 67/1097

(57) ABSTRACT

Alleviating congestion at a receiver may include buffering received packets, selecting packets of the buffer based on an available capacity of the buffer, and notifying senders of the selected packets of a congestion condition in the network interface device. The selecting may be based further on a probability function, which may be configurable. The selecting may include selecting no packets if the available capacity of the buffer is below a minimum threshold, selecting all packets if the available capacity of the buffer meets the maximum threshold, and selecting a number of packets based on the available capacity of the buffer if the available capacity of the buffer is between the minimum and maximum thresholds. Available capacity of the buffer may be determined based on a weighted average available capacity of the buffer and a weighted current available capacity of the buffer.

### TECHNICAL FIELD

Examples of the present disclosure generally relate to alleviating congestion at a receiver for in-cast traffic, including remote direct memory access (RDMA) traffic in a graphics processing unit (GPU) cluster.

### BACKGROUND

In an remote direct memory access (RDMA) cluster of graphics processing units (GPUs), incoming traffic to a receiver (e.g., a network interface device) may result in congestion within the receiver due to bandwidth limitations of the receiver. The congestion may result in packet drops by the receiver, which impacts throughput performance of the receiver, and which may propagate into the network and impact other network devices. Existing approaches for handling congestion are directed to congestion within a network appliance (e.g., a switch).

### SUMMARY

Techniques for alleviating congestion at receiver, including remote direct memory access (RDMA) traffic in a graphics processing unit (GPU) cluster, are described. One example is a system that includes a network interface device that interfaces with other network interface devices over a packet-switched network, where the network interface device includes a buffer to buffer packets received from the other network interface devices, and congestion control circuitry that selects packets of the buffer based on an available capacity of the buffer, and notifies senders of the selected packets of a congestion condition in the network interface device.

Another example described herein is a system-on-chip (SoC) that includes a data processing unit (DPU) and a network interface device that interfaces between the DPU and other network interface devices over a packet-switched network. The network interface device includes a buffer to buffer packets received from the other network interface devices, and congestion control circuitry that select packets of the buffer based on an available capacity of the buffer, and notifies senders of the selected packets of a congestion condition in the network interface device.

Another example described herein is method that includes buffering packets received from network devices in a buffer, selecting packets of the buffer based on an available capacity of the buffer, and notifying senders of the selected packets of a congestion condition in the network interface device.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 depicts a network interface device that includes congestion control circuitry, according to an embodiment.

FIG. 2 depicts regions of a buffer, according to an embodiment.

FIG. 3 depicts a network interface device that includes congestion control circuitry, according to another embodiment.

FIG. 4 depicts a method of alleviating congestion at receiver, according to an embodiment.

FIG. 5 depicts a data processing unit (DPU) that includes congestion control circuitry, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe alleviation of congestion alleviation at a receiver, including congestion of remote direct memory access (RDMA) traffic in a graphics processing unit (GPU) cluster.

Congestion control may be provided by a network switch. This may be useful if the switch is the source of the congestion. If the source of the congestion is a data processing device, switch-based congestion control does not detect the congestion until the congestion impacts the network. Switch-based congestion control may also add work to sender and receiver host devices.

As an example, Explicit Congestion Notification (ECN) is an extension to the Internet Protocol and to the Transmission Control Protocol. An ECN-aware switch/router may set an ECN bit in a packet header to signal impending congestion. A receiver of the packet detects the ECN, and sends a congestion notification packet (CNP) to a sender of the original packet. The sender may then reduce its transmission rate.

As another example, Priority Flow Control (PFC) provides multiple virtual links on a physical link, and permits the links to be paused and restarted independent of one another. A sender may use the virtual links to provide multiple respective classes of service via a switch. If a recipient of one of the classes of service (i.e., traffic of one of the virtual links) is congested, traffic from the sender to the recipient may back-up in the switch (i.e., a buffer-overflow condition in the switch). In such a situation, traffic over the other virtual links may be impacted. In a multi-tiered network topology, PFCs generated due to congestion on a particular class of service, may result in congesting traffic on the same class of service towards other non-congested network interface devices

As disclosed herein, a network interface device includes congestion detection circuitry that detects an approaching congestion condition within the network interface device and notifies packet senders, prior to an actual congestion condition and independent of a data processing unit (DPU) associated with the network interface device. Upon receipt of the notices, the packet senders reduce transmission rates to the network interface device until the condition abates. The network interface device may notify the packet senders via CNPs.

In an example, the congestion detection circuitry monitors the available capacity (i.e., fullness/occupancy) of a packet buffer. If the available capacity of the buffer is below a minimum threshold, the congestion detection circuitry takes no action. If the available capacity of the buffer is above the minimum threshold, the congestion detection circuitry selects a number of packets of the buffer based on the available capacity, and sends notices to senders of the selected packets. In other words, a sender may receive multiple notices depending upon the packets selected. The senders may reduce transmission rates as a function of the number of notifications received by the senders. The senders may subsequently increase the transmission rates as the number of notices dwindle. If the available capacity of the buffer is above a maximum threshold, the congestion detection circuitry may send a notice for each packet in the buffer. The maximum threshold may be set to a level to avoid a buffer-overflow condition (i.e., to avoid dropping packets). The congestion detection circuitry may include configurable parameters to permit a user to manage the responsiveness/aggressiveness of the congestion detection circuitry. The network interface device may set ECN bits of the selected packet for internal purposes.

Alleviating congestion at a receiver may be useful for detecting congestion conditions at an early stage, before the congestion conditions impact performance of a receiver, and before the congestion conditions propagate into the network.

Alleviating congestion by a receiver may be useful to avoid interrupting a host of the receiver.

Alleviating congestion at a receiver may be useful for remote direct memory access (RDMA) applications in graphics processing unit (GPU) clusters.

Alleviating congestion at a receiver may be useful for responding to congestion at the source of the congestion.

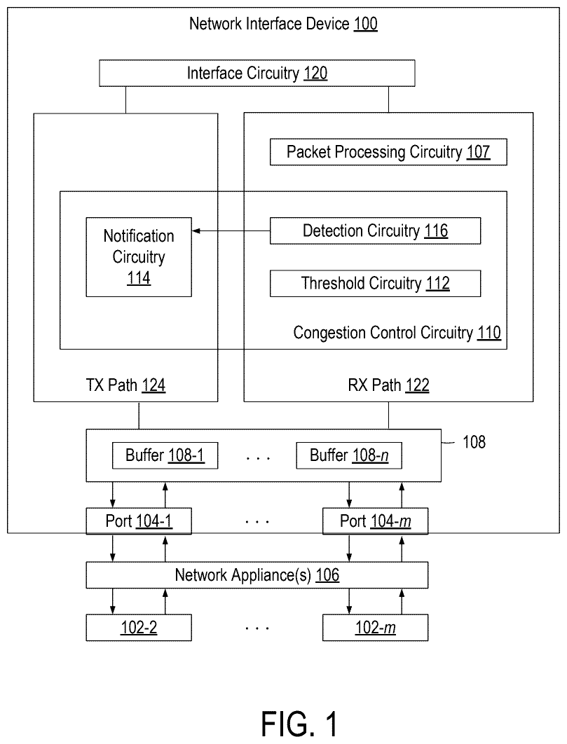

FIG. 1 depicts a network interface device 100 that includes congestion control circuitry 110, according to an embodiment.

Network interface device 100 may communicate with other network interface devices 102-1 through 102-m (collectively, network interface devices 102), over a packet-switched network via ports 104-1 through 104-m (collectively, ports 104), and a network appliance 106 (e.g., a switch). The packets may include, for example and without limitation, remote direct-memory access (RDMA) packets. In examples below, network interface devices 102 may be referred to as packet senders 102 or senders 102.

Network interface device 100 may include interface circuitry 120 that interfaces with one or more other circuit blocks and/or devices such as a host, a memory device, and/or other device(s). Interface circuitry 120 may include circuitry that conforms with a Peripheral Component Interconnect Express (PCIe) standard.

A host may include one or more data processing units (DPUs), which may include a graphics processing unit (GPU). In an example, a host of network interface device 100, and hosts of network interface devices 102-2, form a distributed computing architecture that executes an application program (e.g., an artificial intelligence application program).

In an example, network interface device 100 is a stand-alone device (e.g., an integrated circuit device or a die). In another example, network interface device 100 is integrated with one or more other circuit blocks and/or devices in an integrated circuit device/package. Network interface device 100 and the one or more other circuit blocks and/or devices may be integrated within a single integrated circuit die or across multiple interconnected circuit dies (e.g., in a 2-dimensional side-by-side arrangement and/or a 3-dimensional stack). Network interface device 100 may be integrated as part of a system-on-chip (SoC).

In FIG. 1, network interface device 100 includes a receive (RX) path 122 and a transmit (TX) path 124. RX path 122 includes packet processing circuitry 107 that processes incoming/received packets. Network interface device 100 further includes buffers 108-1 through 108-n (collectively, buffers 108), that buffer packets received via ports 104 for packet processing circuitry 107. Network interface device 100 may assign incoming packets to buffers 108 based on one or more criteria such as, without limitation, priority class of service. A buffer 108 may be designated for use for packets from multiple senders of a given priority class of traffic.

Numbers of packets within buffers 108 may vary over time based on network traffic via ports 104, traffic through interface circuitry 120, and/or a workload of a host of network interface device 100. If the contents of a buffer reaches a capacity of the buffer, additional/subsequent packets assigned to the buffer may be dropped or discarded. The dropped packets may be re-sent by a sender of the dropped packets, which may increase network congestion (i.e., congestions between network interface devices), which may impact processes performed by other network interface devices and/or hosts of the other network interface devices.

To avoid dropped packets, network interface device 100 further includes congestion control circuitry 110 that selectively notifies one or more senders 102 of a congestion condition in network interface device 100 based on available capacity of one or more buffers 108. Congestion control circuitry 110 may include threshold circuitry 112 that selects packets of a buffer 108 based on available capacity of the buffer, and notification circuitry 114 that notifies senders 102 of the selected packets of a congestion condition. Threshold circuitry 112 may select a number of packets of a buffer 108 based on available capacity of the buffer such that, as the available capacity of the buffer increases, threshold circuitry 112 selects greater numbers of packets from the buffer. The number of selected packets may thus be indicative of available capacity of the buffer.

Congestion control circuitry 110 may use different weights, thresholds, and/or methods for different buffers 108.

Notification circuitry 114 may send a notification for each selected packet, such that the number of notifications received by a sender 102 serve as a measure of the congestion. In response to the notifications, the senders 102 may reduce rates at which the senders transmit packets to network interface device 100. The senders 102 may reduce the rates based on the numbers of notifications received by the respective senders. The sender(s) may subsequently increase the transmission rates as the numbers of notifications decrease.

Threshold circuitry 112 may select a number of packets of a buffer 108 based on available capacity of the buffer and a function (e.g., a probability constant). The function may be configurable, which may be useful to permit a user to adjust a responsiveness of threshold circuitry 112 to changes in the available capacity.

Threshold circuitry 112 may select a number of packets of a buffer 108 based on the function if the available capacity of the buffer is above a minimum threshold. If the available capacity of the buffer is below the minimum threshold, notification circuitry 144 threshold circuitry 112 may send no notifications for packets of the buffer.

Threshold circuitry 112 may select all packets of a buffer if the available capacity of the buffer is above a maximum threshold. The maximum threshold may be set below a maximum capacity of the buffer, which may be useful to avoid an actual buffer-overflow condition (i.e., dropped packets).

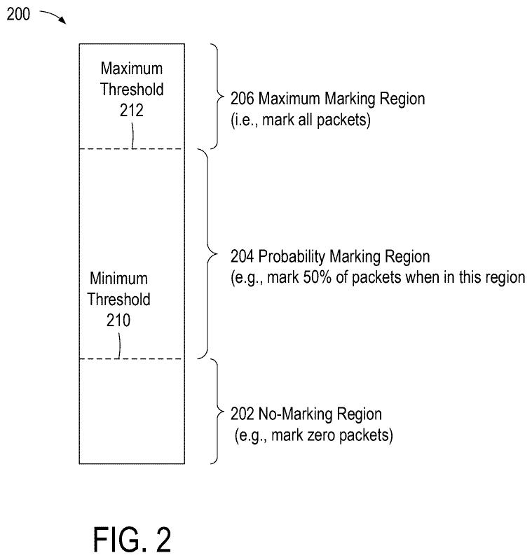

FIG. 2 depicts regions 200 of a buffer, according to an embodiment. Regions 200 include a no-marking region 202 defined by a minimum threshold 210, a maximum marking region 206 defined by a maximum threshold 212, and a probability marking region 204 defined by minimum threshold 210 and maximum threshold 212.

In FIG. 1, threshold circuitry 112 may determine available capacity of a buffer 108 based on a current/instantaneous available capacity of the buffer, an average of the available capacity, or a combination thereof. Considering the average available capacity of the buffer may be useful to dampen or smooth responsiveness to abrupt and short-term congestion conditions. In an example, threshold circuitry 112 determines available capacity of a buffer 108 based a weighted average available capacity of the buffer and a weighted current/instantaneous available capacity of the buffer. The weights may be configurable, which may be useful to permit a user to control responsiveness. Threshold circuitry 112 may determine available capacity of a buffer 108 based on EQ. 1.

$$avg\_fullness = ( ( 1 - w ) * previous\_avg \_fullness ) + ( w * current\_fullness ) \qquad EQ . 1$$

where w is a weight that is configurable from 0 to 1.

Threshold circuitry 112 may select a number of packets of a buffer 108 based on equation 2 (EQ. 2).

$$n u {m}_{packets} = \frac{k * ( avg\_fullness - minimum\_threshold )}{( maximum\_threshold - minimum\_threshold )} \qquad ( EQ . 2 )$$

where k is a probability constant that is configurable from 0 to 1.

Threshold circuitry 112 is not limited to the examples of EQ. 1 or EQ. 2.

Threshold circuitry 112 may mark the selected number of packets of a buffer 108, such as by setting a flag/bit in a header field of the packets (e.g., an ECN bit). In this example, congestion control circuitry 110 may further include detection circuitry 116 that identifies/detects packets for which the flag/bit is set in the header field, and that provides information regarding senders of the identified packets to notification circuitry 114, to permit notification circuitry 114 to notify the senders. Notification circuitry 114 may notify senders via CNPs. Notification circuitry 114 is not, however, limited to notifying senders via CNPs.

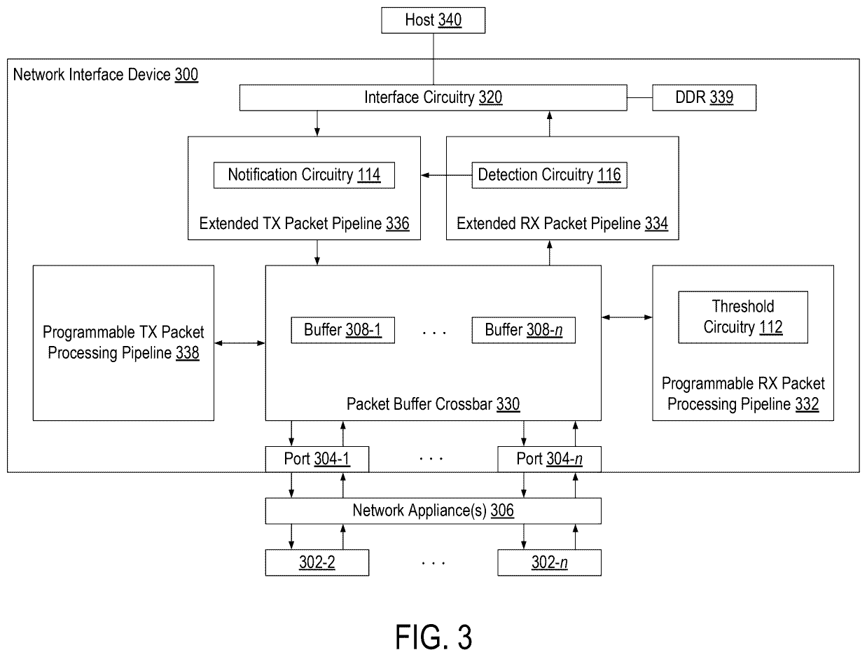

FIG. 3 depicts a network interface device 300 that includes congestion control circuitry, according to an embodiment. Network interface device 300 may communicate with other network interface devices 302-1 through 302-m (collectively, network interface devices 302), over a packet-switched network via ports 304-1 through 304-m (collectively, ports 304), and a network appliance 306 (e.g., a switch), such as described above with respect to network interface device 100 in FIG. 1.

Network interface device 300 includes a packet buffer crossbar 330 that includes buffers 308-1 through 308-n (collectively, buffers 308). Buffers 308 receive packets from ports 304, such as described above with respect to buffers 108 in FIG. 1.

Network interface device 300 further includes a programmable receive (RX) packet processing pipeline 332 that performs programmable processes on packets of buffers 308, and forwards results of the programmable processes to an extended receive (RX) packet processing pipeline 334 via packet buffer crossbar 330. Extended receive (RX) packet processing pipeline 334 may perform, for example and without limitation, direct memory access (DMA) of packet of packet content to host memory, generating acknowledgements/congestion notifications packets to senders, and/or other functions.

Network interface device 300 may further include a programmable transmit (TX) packet processing pipeline 338 that performs programmable processes on outgoing packets.

Network interface device 300 may further include random access memory, depicted here as double-data-rate (DDR) memory 339, and/or interface circuitry 320. In the example of FIG. 3, interface circuitry 320 interfaces with DDR memory 339 and a host 340. Host 340 may include one or more data processing units (DPUs), which may include, for example and without limitation, one or more graphics processing units (GPUs).

In the example of FIG. 3, a congestion condition may arise due to a bandwidth limitations within network interface device 300 (e.g., between interface circuitry 320 and DDR memory 339, between interface circuitry 320 and host 340, and/or between other circuit blocks). The bandwidth limitations may apply back-pressure to packet buffer crossbar 330. Absent congestion control circuitry, the back-pressure may result in a buffer-overflow condition and dropped packets at ports 304.

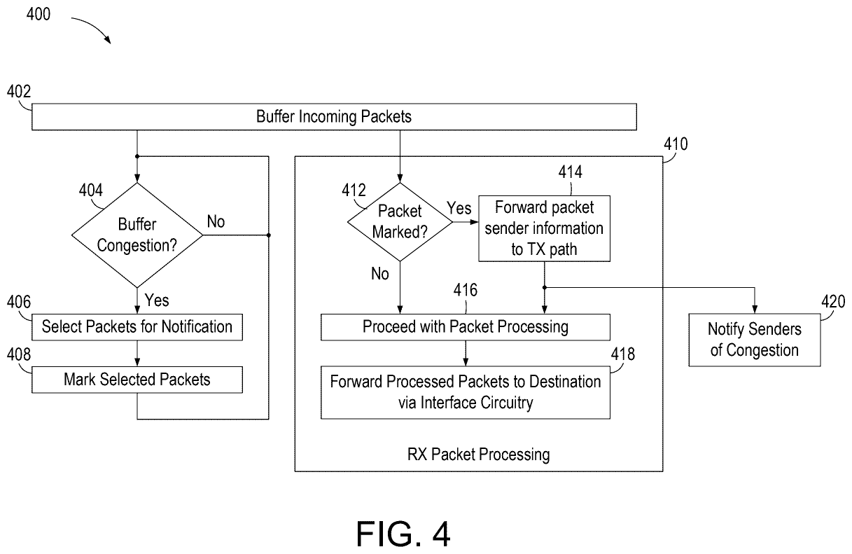

In FIG. 3, programmable receive (RX) packet processing pipeline 332 includes threshold circuitry 112. In this example, packet buffer crossbar 330 may maintain buffer depth information for buffers 308, and may provide the buffer depth information to threshold circuitry 112 via internal headers of packets of the buffers. Further in FIG. 3, extended receive (RX) packet processing pipeline 334 includes detection circuitry 116, and extended transmit (TX) packet processing pipeline 336 includes notification circuitry 114. Network interface device 300 is further described below with reference to FIG. 4.

FIG. 4 depicts a method 400 of alleviating congestion at receiver, according to an embodiment. Method 400 is described below with reference to FIGS. 2 and 3.

At 402, network interface device 300 buffers incoming packets (e.g., RDMA packets) in one or more buffers 308.

At 404, threshold circuitry 112 monitors buffers 308 for congestion. Threshold circuitry 112 may determine an available capacity of a buffer based on EQ. 1, and may compare the available capacity to minimum threshold 210 and maximum threshold 212. If buffers 308 are not congested (e.g., if available capacity is within no marking region 202), threshold circuitry 112 may take no action, and may continue monitoring buffers 308. If a buffer is congested (e.g., if available capacity is within probability marking region 204 or maximum marking region 206), processing proceeds to 406.

At 406, threshold circuitry 112 selects packets of the congested buffer(s) 308 for marking. If the available capacity of the buffer exceeds maximum threshold 212, threshold circuitry 112 may select and mark all packets of the buffer. If the available capacity of the buffer is between minimum threshold 210 and maximum threshold 212, threshold circuitry 112 may select a number of packets of a congested buffer based on EQ. 2.

At 406, threshold circuitry 112 marks the selected packets, such as described further above.

At 410, extended RX packet processing pipeline 334 processes packets of buffers 308. During processing of the packets, detection circuitry 116 examines internal headers of the packets at 412. If detection circuitry 116 detects bits (e.g., ECN bits) within the internal packets, processing proceeds to 414, where detection circuitry 116 sends information regarding senders of the packets to notification circuitry 114 in extended TX packet processing pipeline 336. At 418, extended RX packet processing pipeline 334 forwards processed packed data (e.g., payloads) to a destination (e.g. host 340 and/or DDR memory 339) via interface circuitry 320.

At 420, extended TX packet processing pipeline 336 sends notification packets (e.g., CNPs) to senders of the packets based on the information from detection circuitry 116.

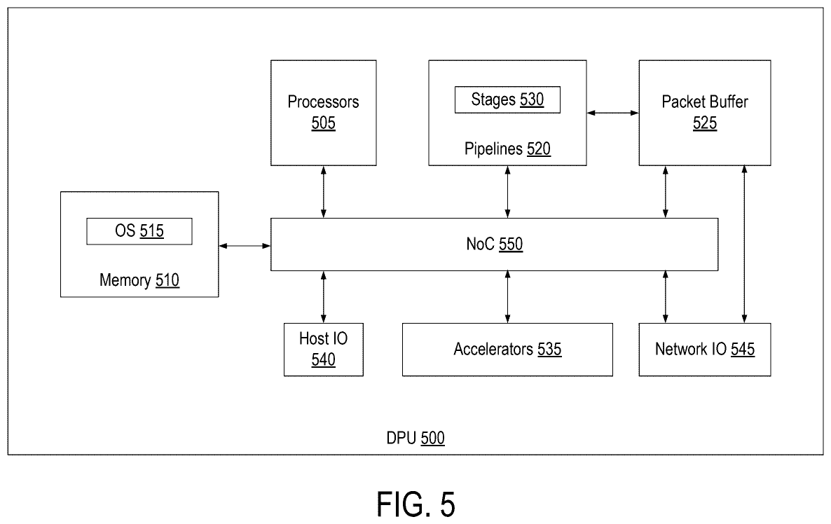

FIG. 5 depicts a data processing unit (DPU) 500 that includes congestion control circuitry, according to an embodiment. In one embodiment, the DPU 500 is a programmable processor designed to efficiently handle data-centric workloads such as data transfer, reduction, security, compression, analytics, and encryption, at scale in data centers. The DPU 500 can improve the efficiency and performance of data centers by offloading workloads from a host central processing unit (CPU) or graphic processing units (GPUs). While CPUs and GPUs can specialize on compute, the DPU 500 may specialize in data movement. The DPU 500 can communicate with host CPUs and GPUs to enhance computing power and the handling of complex data workloads.

The DPU 500 includes a plurality of processors 505. In one embodiment, the processors 505 include any number of processing cores. In one embodiment, the processors 505 may be CPUs. The processors 505 can form one or more CPU core complexes. The processors 505 can be any hardware circuitry that uses an instruction set architecture (ISA) to process data, such as a complex instruction set computer (CISC) or reduced instruction set computer (RISC).

The memory 510 can include volatile or non-volatile memory such as random access memory (RAM), high bandwidth memory (HBM), and the like. The memory 510 can include an operating system (OS) 515 that is separate from the host OS.

In one embodiment, the DPU 500 may be in (or be used to implement) a network interface controller/card (NIC) such as a SmartNIC that processes packets before they are forwarded to a host (e.g., a host CPU or GPU). In one embodiment, the DPU 500 is a fully programmable P4 DPU. The DPU 500 includes multiple pipelines 520 (which can be the same type or different types) for processing received network packets stored in a packet buffer 525. In this example, the pipelines 520 has direct connections to the packet buffer 525.

The pipelines 520 can operate in parallel. Further, the pipelines 520 can be the same type of pipeline (e.g., perform the same tasks). In other embodiments, the DPU 500 may have different types of pipelines 520. For example, the DPU 500 could include networking pipelines which perform networking tasks such as combining packets that were subdivided to be compatible with a maximum transmission unit (MTU) or for dealing with one or more host operating systems, drivers, and/or message descriptor formats in host memory, and could also include direct memory access (DMA) pipelines which perform memory reads and writes.

The pipelines 520 include multiple stages 530 where received packet data is processed at each stage 130 before being passed to the next stage. This packet data could be the entire packet or just a portion of the packet. For example, a parser in the DPU 500, which is upstream from the pipelines 520, may parse out a particular portion of a received packet (e.g., a packet header vector (PHV)) which is then sent to the one of the pipelines 520.

The stages 530 can include circuitry or hardware. In one embodiment, the stages 130 can be programmed using a pipeline programming language, such as P4. In one example, the stages 530 in one pipeline 520 perform the same functions of the stages 530 in another pipeline 520. However, in other embodiments, the stages may perform different functions.

In addition to the stages, the pipelines 520 may each include memory, which can be referred to as local memory. This memory can store local tables that indicate how, or if, a particular packet should be processed at the stages 530. For example, one of the stages in the pipelines 520 can perform a lookup to read a policing entry in a table to determine whether an entity associated with the packet has exceeded a rate limit (e.g., a packet rate limit, a data rate limit, or both).

The DPU 500 can include accelerators 535 to perform specialized tasks associated with data movement. The accelerators 535 may include a cryptography accelerator, a data compression accelerator, accelerators for performing regex or dedupe, and/or other accelerators.

To communicate with the host and a network, the DPU 500 includes a host input/output (IO) 540 and network IO 145. The host IO 540 can include a PCIe interface, or any suitable protocol for communicated with a CPU or GPU in the host. The network IO 545 can include Ethernet interfaces, and the like for communicating with a network.

The DPU 500 includes a packet-based network-on-chip (NoC) 550 for interconnecting the various components discussed above. While a NoC is disclosed, the DPU 500 can include any suitable on-chip network. While some components in the DPU 500 may rely on the NoC 550 to communicate with other components, the DPU 500 can also include connections between components that bypass the NoC 550. For example, the packet buffer 525 can have a connection to the network IO 545 that bypasses the NoC 550. Similarly, the pipelines 520 can exchange packet data with the packet buffer 525 without having to rely on the NoC 550. However, to transfer data to the processors 505, the pipelines 550 may use the NoC 550.

In one embodiment, the DPU 500 includes security and management features such as offering a hardware root of trust, secure boot, and the like.

In the example of FIG. 5, packet buffer 525 may include buffers 108, pipelines 520 may include threshold circuitry 112 and detection circuitry 116, and a transmit path of network IO 545 may include notification circuitry 114.

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. A system, comprising:
a network interface device configured to interface with other network interface devices over a packet-switched network, wherein the network interface device comprises:
a buffer configured to buffer packets received from the other network interface devices, and
congestion control circuitry configured to select packets of the buffer based on available capacity of the buffer, and to notify senders of the selected packets of a congestion condition in the network interface device, wherein the senders comprise one or more of the other network interface devices.

2. The system of claim 1, wherein the congestion control circuitry is further configured to:
select a number of the packets of the buffer based on the available capacity of the buffer if the available capacity of the buffer is below a maximum threshold; and
select all packets of the buffer if the available capacity of the buffer meets the maximum threshold.

3. The system of claim 2, wherein the congestion control circuitry is further configured to select the number of the packets of the buffer based on the available capacity of the buffer and a function configured to permit a user to adjust a responsiveness of the congestion control circuitry to changes in the available capacity of the buffer.

4. The system of claim 2, wherein the congestion control circuitry is further configured to:
select no packets of the buffer if the available capacity of the buffer is below a minimum threshold.

5. The system of claim 1, wherein the congestion control circuitry is further configured to:
determine the available capacity of the buffer based on a weighted average available capacity of the buffer and a weighted current available capacity of the buffer.

6. The system of claim 5, wherein:
a weight of the weighted average available capacity is configurable; and
a weight of the weighted current available capacity is configurable.

7. The system of claim 1, wherein the network interface device further comprises:
a programmable receive packet processing pipeline configured to select the packets of the buffer based on the available capacity of the buffer, and to populate a field in headers of the selected packets with a bit value;
an extended receive packet processing pipeline configured to detect the bit values in the headers, and to output information regarding senders of the selected packets; and
an extended transmit packet processing pipeline configured to notify the senders of the selected packets of the congestion condition in the network interface device based on the information regarding the senders of the selected packets.

8. The system of claim 1, wherein the network interface device is further configured to:
transmit packets to a first one of the other network interface devices at a data rate; and
receive messages from the first one of the other network interface devices that indicate a congestion condition in the first one of the other network interface devices; and
reduce the data rate based on a number of the messages from the first one of the other network interface devices.

9. The system of claim 1, wherein the packets comprise remote direct memory access (RDMA) packets.

10. An integrated circuit device, comprising:
a data processing unit (DPU), comprising:
network input/output (IO) circuitry configured to interface with remote devices over a packet-switched network;
a packet buffer configured to store packets received from the remote devices by the network IO circuitry;
a receive packet processing pipeline configured to process the packets stored in the packet buffer;
a transmit packet processing pipeline configured to process packets destined for the remote devices;
a packet-based network-on-chip (NoC) configured to interface with the network IO circuit, the packet buffer, the receive packet processing pipeline, and the transmit packet processing pipeline; and
congestion control circuitry configured to select packets of the packet buffer based on an available capacity of the packet buffer, and to notify senders of the selected packets of a congestion condition in the DPU, wherein the senders comprise one or more of the remote devices.

11. The integrated circuit device of claim 10, wherein the DPU further comprises:
a processor;
memory configured to store instructions and data for the processor;
a host interface configured to interface with a host device; and
one or more accelerator circuits configured to provide services to the host device,
wherein the NoC is further configured to interface with the processor, the memory, the host interface, and the one or more accelerator circuits.

12. The integrated circuit device of claim 10, wherein the packets comprise remote direct memory access (RDMA) packets.

13. The integrated circuit device of claim 10, wherein:
the network IO circuit comprises a packet buffer crossbar comprising the packet buffer, wherein the packet buffer crossbar is configured to populate headers of the packets of the packet buffer with measures of the available capacity of the buffer;
the receive packet processing pipeline comprises a programmable receive packet processing pipeline configured to select the packets of the buffer based on the measures of the available capacity of the buffer, and to populate a field in headers of the selected packets with a bit value;
the receive packet processing pipeline further comprises an extended receive packet processing pipeline configured to detect the bit values in the headers, and to output information regarding senders of the selected packets; and
the transmit packet processing pipeline is configured to notify the senders of the selected packets of the congestion condition in the DPU based on the information regarding the senders of the selected packets.

14. The integrated circuit device of claim 10, wherein the congestion control circuitry is further configured to:
select no packets of the packet buffer if the available capacity of the packet buffer is below a minimum threshold;
select all packets of the packet buffer if the available capacity of the packet buffer meets a maximum threshold; and
select a number of packets of the packet buffer based on the available capacity of the packet buffer if the available capacity of the packet buffer is between the minimum threshold and the maximum threshold.

15. The integrated circuit device of claim 14, wherein the congestion control circuitry is further configured to select the number of the packets of the packet buffer based on the available capacity of the packet buffer and a function configured to permit a user to adjust a responsiveness of the congestion control circuitry to changes in the available capacity of the packet buffer.

16. The integrated circuit device of claim 10, wherein the congestion control circuitry is further configured to:
determine the available capacity of the packet buffer based on a weighted average available capacity of the packet buffer and a weighted current available capacity of the packet buffer,
wherein weights of the weighted average available capacity and the weighted current available capacity are configurable.

17. A method, comprising:
buffering packets received from network devices in a buffer;
selecting packets of the buffer based on an available capacity of the buffer; and
notifying senders of the selected packets of a congestion condition, wherein the senders comprise one or more of the network devices.

18. The method of claim 17, wherein the selecting comprises:
selecting no packets of the buffer if the available capacity of the buffer is below a minimum threshold;
selecting all packets of the buffer if the available capacity of the buffer meets a maximum threshold; and
selecting a number of the packets of the buffer based on the available capacity of the buffer if the available capacity of the buffer is between the minimum threshold and the maximum threshold.

19. The method of claim 18, wherein the selecting comprises:
selecting the number of the packets of the buffer based on the available capacity of the buffer and a function configured to permit a user to adjust a responsiveness of the selecting to changes in the available capacity of the buffer.

20. The method of claim 17, further comprising:
determining the available capacity of the buffer based on a weighted average available capacity of the buffer and a weighted current available capacity of the buffer,
wherein weights of the weighted average available capacity and the weighted current available capacity are configurable.
